(19) United States
(12) Patent Application Publication
(10) Pub. No.: US 2017/0120708 A1
(43) Pub. Date: May 4, 2017

(54) VEHICLE SPRING ASSEMBLY

(71) Applicant: Ford Global Technologies, LLC, Dearborn, MI (US)

(72) Inventors: Daniel Mainz, Herzogenrath (DE); Friedrich Peter Wolf-Monheim, Aachen (DE); Nicole Zandbergen, Wurselen (DE); Paul Zandbergen, Wurselen (DE); Ralf Hintzen, Aachen (DE); Timothy Drotar, Commerce Township, MI (US)

(73) Assignee: Ford Global Technologies LLC, Dearborn, MI (US)

(21) Appl. No.: 15/337,859

(22) Filed: Oct. 28, 2016

(30) Foreign Application Priority Data
Oct. 29, 2015 (DE) DE102015221126.6

(51) Int. Cl. B60G 11/52

(52) U.S. Cl. CPC B60G 11/52; B60G 2204/1244; B60G 2206/42

(57) ABSTRACT

A spring system for a motor vehicle including a spring extending along an extension axis (A) and supported on a spring seat by a resilient spring support. The spring seat including a rigid support structure positioned radially inside the spring. The spring support having a side portion, positioned between the support structure and the spring, and a front portion, connected to the side portion, located axially in front of the spring. The spring exerts a force against the side portion and the side portion exerts a force against the support structure. The spring system provides vibration damping and spring stabilization relative to lateral forces.

### CROSS-REFERENCE TO RELATED APPLICATIONS

Not Applicable.

### BACKGROUND OF THE INVENTION

1. Field of the Invention

The invention relates to a spring assembly for a motor vehicle and, more specifically, to a spring and spring support for use with a wheel carrier.

2. Description of Related Art

Modern motor vehicles typically include a wheel suspension system. Such systems include a wheel carrier, forming a receiver for the vehicle wheel, connected through one or more control arms (for example transverse control arms and longitudinal control arms) to the vehicle chassis. The control arm both guides the wheel carrier and insurers movement of the wheel carrier relative to the vehicle structure, i.e. the chassis and vehicle body. The suspension system uses a spring arranged and providing a restoring force between the wheel carrier and vehicle structure. The spring, generally produced from spring steel, extends between the wheel carrier or a control arm and the vehicle structure. The path of the spring may be more or less vertical, but in some cases, a marked inclination in the longitudinal or transverse direction of the vehicle may also be present.

Spring plates provide a sufficiently large and flat surface for the spring, where the edge of the spring plate is configured as a flange that encloses the end of the spring to prevent lateral displacement. Sometimes, the spring is not directly supported on a metal part, for example the spring plate. Instead, a spring support formed of a resilient material, for example rubber, to dampen vibrations, is placed between the spring and spring plate. The spring support absorbs forces acting in the longitudinal direction of the spring. The spring support may also absorb forces in the transverse direction. Finally, depending on the resiliency of the spring support it may not stabilize spring position in the case of forces acting laterally.

### SUMMARY OF THE INVENTION

A spring assembly including a spring extending along an extension axis contacting a resilient spring support having a side portion and a front portion. A spring seat having a rigid support structure located radially inside the spring with the spring support side portion between the support structure and the spring. The system includes the spring support front portion connected to the spring support side portion and located axially in front of the spring wherein the spring exerts a force against the spring support side portion and the spring support side portion exerts a force against the support structure.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a partial, sectional view of a spring assembly according to a first embodiment of the invention.

FIG. 2 shows a partial, sectional view of a spring assembly according to a second embodiment of the invention.

FIG. 3 shows a partial, sectional view of a spring assembly according to a third embodiment of the invention.

FIG. 4 shows a partial, sectional view of a spring assembly according to a fourth embodiment of the invention.

### DETAILED DESCRIPTION OF THE PREFERRED EMBODIMENTS

The following description of the preferred embodiment(s) is merely exemplary in nature and is in no way intended to limit the invention, its application, or uses.

In the various figures, the same parts are always provided with the same reference numerals, which is why these parts are also only generally described once. The figures are in a direction extending in or along the X-axis (longitudinal axis) of the vehicle, i.e., they show a section corresponding to the Y-Z plane.

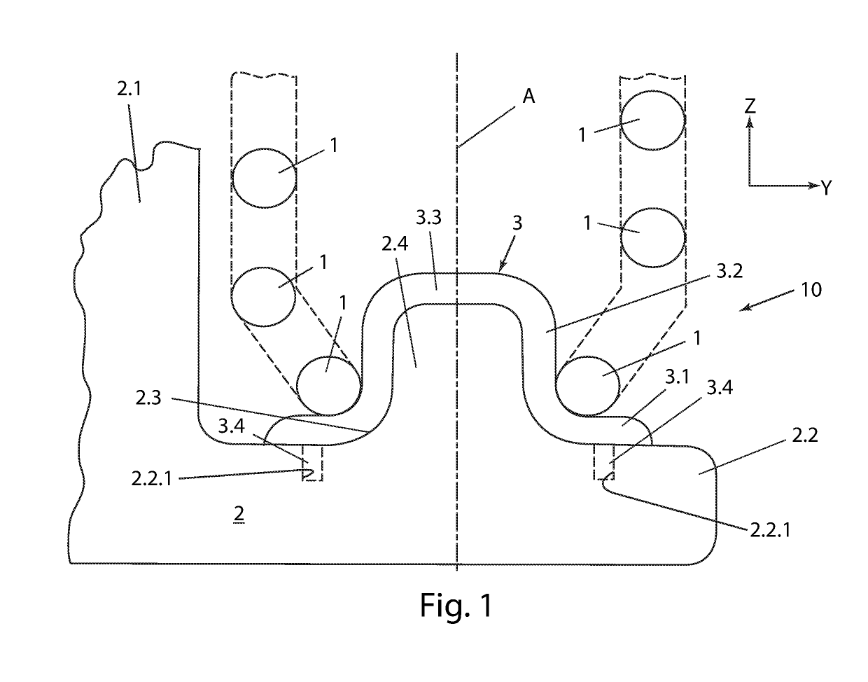

FIG. 1 shows a sectional view of a spring assembly 10 for use with a vehicle according one example of the present invention. A spring 1 extends between a wheel carrier 2 and a vehicle structure (of a vehicle body or a chassis) not shown here. Control arms (not shown) also connect the wheel carrier 2 to the vehicle structure. The wheel carrier 2 has a base portion 2.1 and an extension 2.2 extending from the base portion 2.1 in the direction of the Y-axis (transverse axis). A pin-like rigid support structure 2.4 rises upward on the extension 2.2 said in the direction of the Z-axis (vertical axis). The support structure 2.4 forms a part of a spring seat 2.3 for the spring 1. The Z-axis extends parallel to an extension axis A of the spring 1, which in the present example corresponds to the spring centerline. The extension axis A defines a coordinate system having an axial, radial, and tangential direction. The spring seat 2.3 and the support structure 2.4 are shown in the present example as one piece with the extension 2.2; alternatively, they could be produced separately and welded, riveted, or fixedly connected thereto in a different manner. In one example, the support structure 2.4 is formed of aluminum, as is the rest of the wheel carrier 2, but a different material with a sufficient stiffness could also be used.

The support structure 2.4 is rotationally symmetrical about the extension axis A. A resilient spring support 3 is arranged on the support structure 2.4 and on the adjacent parts of the extension 2.2. The spring support 3 configured in a bell-like manner. In the present example, the spring support 3 is formed from rubber; but other materials, for example elastomers, could be used. A circular-like front portion 3.1 of the spring support 3 is arranged in the axial direction in front of the spring 1 and/or between the spring 1 and the extension 2.2, the front portion 3.1 absorbing axial forces between the spring 1 and the spring seat 2.3 and/or the wheel carrier 2.

A side portion 3.2 of the spring support 3 adjoins the front portion 3.1. The side portion 3.2 circling, in a tangential manner, and enclosing the support structure 2.4. In the radial direction, the side portion 3.2 is between the spring 1 and the support structure 2.4, where the spring 1 and the side portion 3.2 exert a force against one another and the side portion 3.2 and the support structure 2.4 exert a force against one another, without clearance in both instances. The spring 1 supported through the side portion 3.2 on the support structure 2.4. The support structure 2.4 and the side portion 3.2 absorbing forces between the spring 1 and the wheel carrier 2 acting transversely to the axial direction. Although the spring support 3 is resilient and perhaps does not sufficiently support the spring 1; the support structure 2.4 is rigid and sufficiently stable to stabilize the spring support 3 and the spring 1. A closure portion 3.3 extends radially inwardly from the side portion 3.2 and terminates or forms an upward portion or a top of the spring support 3 (relative to the Z-axis).

Both the support structure 2.4 and the spring support 3 are configured substantially rotationally symmetrical relative to the extension axis A. Because the spring support 3 may twist relative to the support structure 2.4, a plurality of pins 3.4 integrally formed on the front portion 3.1 engage complementary bores 2.2.1 in the extension 2.2 forming a positive connection that prevents twisting.

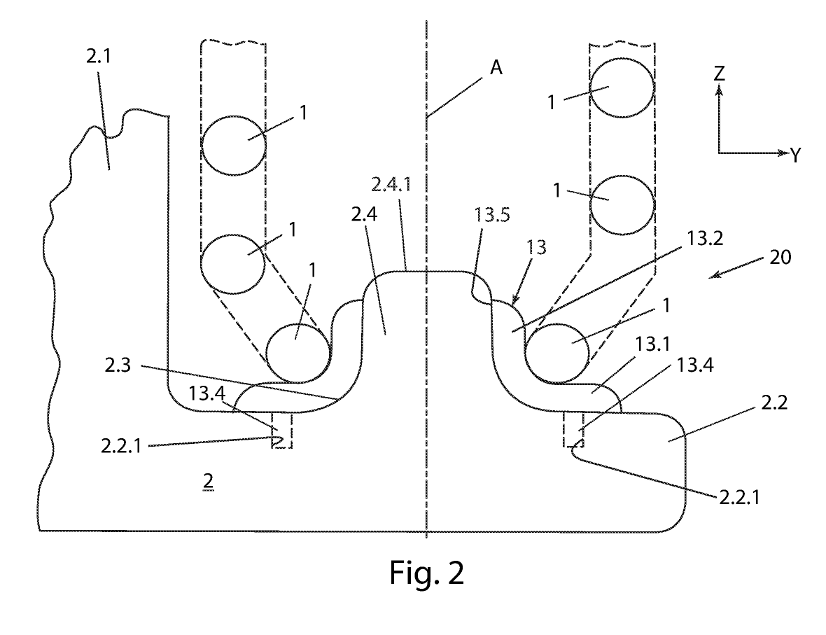

FIG. 2 shows an alternative embodiment of a spring arrangement 20 similar to the spring arrangement 10 shown in FIG. 1. The spring support 13 shown also includes a front portion 13.1 with pins 13.4 and a side portion 13.2; however, a closure portion is not provided. Instead, the side portion 13.2 surrounds an opening 13.5 at an upper end 2.4.1 of the support structure 2.4 protruding through the opening.

As illustrated, the spring assembly 10 includes a spring 1 extending along an extension axis A and supported on at least one spring seat 2.3 through a resilient spring support 3. The spring 1 in this example may be made of spring steel; however, the spring 1 may be made of a different material, for example fiber-reinforced plastics or a composite material. The extension axis A corresponds to the direction of extension of the spring 1 and may optionally coincide with an axis of symmetry and/or spring centerline of the spring 1. However, the spring need not be of symmetrical construction. The spring 1 is primarily supported in the axial direction on the spring seat 2.3 and connects an unsprung mass of the vehicle to a sprung mass of the vehicle. The regions on the sprung and/or unsprung components on which the spring is supported are identified as the “spring seat.” In this context, the term is not understood as limiting the shape, configuration, or area of the “spring seat.” A “spring seat” may be provided for each end of the spring.

As shown, the spring 1 is supported on at least one spring seat 2.3 through a resilient spring support 3. The spring exerts no direct force (or at least not everywhere) against the spring seat 2.3; instead, a resilient spring support 3 is interposed therebetween. The spring support 3 may be formed, at least substantially, of rubber or an elastomer.

As shown, the support structure 2.4 of the spring seat 2.3 is arranged radially inside the spring 1. The spring support 3 has a side portion 3.2 arranged between the support structure 2.4 and the spring 1 and a front portion 3.1 connected thereto and arranged axially in front of the spring 1. The support structure 2.4 is located radially inside the spring 1. The support structure 2.4 is inside the spring, that is, in the axial direction the support structure 2.4 protrudes into the interior of the spring 1. The support structure 2.4 is rigid similar to the majority of parts of the vehicle suspension and compared to the spring support 3 it is non-resilient. Preferably, the support structure 2.4 is not only rigid but also rigidly connected to the spring seat 2.3 and/or even forms part thereof. The side portion 3.2 of the spring support 3 is between the support structure 2.4 and the spring 1, in the radial direction. The term “side portion” is in no way limiting regarding the shape and only describes that the side portion is arranged to a certain extent to the side of the support structure 2.4. In certain embodiments, the side portion may be shaped as an outer casing, for example like a cylinder casing or frustoconical casing. The front portion 3.1, connected directly or indirectly to the side portion 3.2, positioned in front of the spring 1 in the axial direction. As shown, the front portion 3.1 is arranged between the spring seat 2.3, on which the spring 1 is supported, and the spring 1. As shown, the front portion 3.1 located, to a certain extent, on the front face of the spring 1.

The front portion 3.1 serving primarily to absorb static and dynamic forces, acting parallel to the extension axis A, between the spring 1 and the spring seat 2.3. The support structure 2.4 and the interposed side portion 3.2 absorb forces acting transversely to the extension axis A. During assembly, the support structure 2.4 helps position the spring 1 and secures the position of the spring 1 in the assembled state. In the disclosed example, the spring support 3 may be configured to be resilient and supported by the support structure 2.4. The support structure 2.4 may be made from metal, for example steel, but also other sufficiently stable materials, like for example fiber-reinforced plastics might be conceivable. The support structure 2.4 may optionally be solid, but typically, it is configured to be hollow and/or shell-like, for example configured as a sheet metal part. The support structure 2.4 and/or the side portion 3.2 may be configured to be rotationally symmetrical relative to the extension axis A. The same may also apply to the front portion 3.1.

As shown, the spring 1 exerts a force against the side portion 3.2 of the spring support 3. In addition, the side portion 3.2 of the spring support 3 exerts a force against the support structure 2.4. The parts configured or dimensioned so they engage one another without clearance. The side portion 3.1 of the spring support 3 and the support structure 2.4 supports the spring 1. The parts need not exert a force against one another over their entire surface. For example, just the lower most portion of the spring exerts a force against the side portion 3.1 of the spring support 3. Similarly, intermediate spaces may exist in regions between the support structure 2.4 and the side portion 3.1, without this substantially impairing spring 1 support.

In one example, the side portion 3.1 could be limited to a partial region and/or a plurality of partial regions around the support structure 2.4. In this case, one or more intermediate spaces between the spring 1 and the support structure 2.4 would exist that, depending on the size and distribution would not substantially impair spring 1 support. Preferably, the side portion 3.1 circles tangentially around the support structure 2.4. For example, if a plane perpendicular to the axial direction is considered, the side portion 3.1 surrounds the support structure 2.4. The present example simplifies the spring support 3 and increases the stability thereof. Possible weight savings, for example, involving through-holes in the side portion 3.1, are normally insignificant due to the low density of the spring support 3.

As shown in FIG. 1 the spring support 3 has a closure portion 3.3 closing the side portion 3.2 at the upper end thereof. The closure portion 3.3 may simplify production of the spring support 3 and increase stability thereof. The closure portion 3.3 adjoins the side portion 3.2 in the axial direction and extends radially inwardly, whereby the two portions form a bell-like structure that encloses the support structure 2.4. The spring support 3 may protect the support structure 2.4, for example from corrosion or mechanical damage. In particular, the closure portion 3.2 may be dimensioned so it absorbs and transmits the spring 1 force at least partly or even fully against the support structure 2.4.

As shown in FIG. 2, the spring support 13 may be formed so the side portion 13.2 bounds an opening 13.5, where the upper end 2.4.1 of the support structure 2.4 protrudes through the opening 13.5 in the axial direction. This arrangement saves material, and with a long support structure 2.4, the lateral support and/or the protection of the spring 1 from loss may be increased.

Although sufficient for supporting the side portion and the spring, the support structure 3 has more or less closed surfaces in the radial direction. In addition, the support structure 3 is closed in the axial direction; see FIG. 1, such that in the axial direction there is no continuous opening inside the support structure 3 forming a closed surface. The support structure 3 of FIG. 1 forming a stable structure and preventing dirt or other contaminants from penetrating an inner region thereof.

A component of a suspension system of a vehicle may include a spring seat 2.3. For example, the component may be a control arm, like a transverse control arm. The component may also be a wheel carrier wherein the spring seat 2.3 is rigidly connected to a wheel carrier (including the seat structure).

In the disclosed example, the support structure 2.4 is configured on an extension of the wheel carrier extending horizontally. Here the term “horizontally” refers to the installed position inside the vehicle where such an extension may extend toward the transverse axis (Y-axis) of the vehicle toward the vehicle center. This extension forms, to a certain extent, a base or platform from which the support structure 2.4 protrudes, for example toward the extension axis A, typically more or less parallel to the vertical axis (Z-axis). The support structure 2.4 may be configured integrally with the extension or, for example, welded thereto. The extension may be welded to the remainder of the wheel carrier or at least partly integrally manufactured therewith.

The support structure 2.4 is configured to be substantially rotationally symmetrical, so the side portion 3.2 and the spring support 3 could twist. This is generally undesirable, when for example the side portion 3.2 of the spring support 3 facing the spring 1 has a shape deviating from rotational symmetry. For example, it is adapted to an end of a spiral of the spring 1. So according to one embodiment the front portion 3.1 and the spring seat 2.3 have interlocking axially extending locking structures 3.4, 2.2.1 preventing a tangential displacement of the spring support 3. The locking structures 3.4, 2.2.1 form a partial positive connection preventing the spring support 3 from being tangentially displaced, i.e. twisted relative to the support structure 2.4. The respective locking structures 2.2.1, 3.4 may be configured, in particular, to be complementary to one another so one structure forms the negative shape of the other structure. Such locking structures predetermined a specific installed position of the spring support 3 during assembly leading to a simplification of the mounting process. Protection against twisting of the spring support 3 also reduces undesirable noise development caused by relative displacement between the spring support 3 and the support structure 2.4.

In particular, the locking structures may include at least one bore 2.2.1 configured in the spring seat 2.3 and a pin element 3.4 complementary thereto and configured on the front portion 3.1 of the spring support 3. The bore 2.2.1 and the pin element 3.4 may, for example, extend parallel to the extension axis A. The pin element 3.4 is cylindrical, but may also have a structured surface or, in particular with a throughbore, have a barbed hook or detent member at the end to improve the engagement with the bore 2.2.1. A plurality of such bores and pin elements, arranged at uniform or non-uniform angular spacing around the support structure, may also be used.

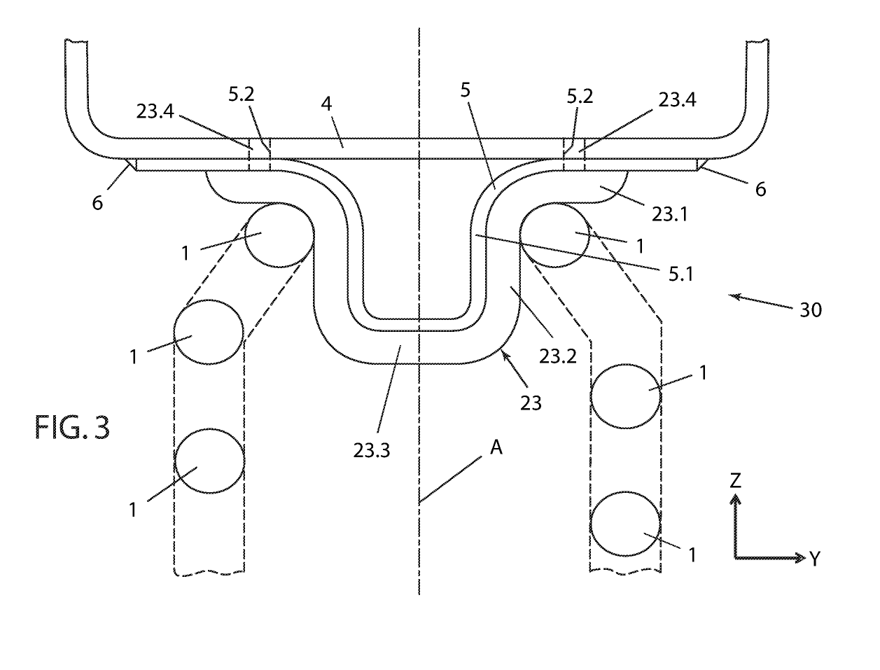

FIG. 3 shows a further embodiment of a spring arrangement 30 combinable with the spring arrangements 10, 20 in FIGS. 1 and 2. The sectional view in FIG. 3 shows a longitudinal member 4, a spring seat 5 configured as a sheet metal part fastened the longitudinal member by welded seams 6.

The longitudinal member 4 forms a part of a sprung mass of the motor vehicle. A spring 1, seen in FIG. 3, is like the spring in FIGS. 1 and 2. The spring 1 supported on a spring support 23 on the longitudinal member 4 and/or on the spring seat 5. The spring seat 5 also forms here a support structure 5.1 protruding downwardly in the axial direction. The support structure 5.1 and the spring support 23 configured to be rotationally symmetrical relative to an extension axis A of the spring 1 and substantially correspond in shape to the elements in FIG. 1. The spring support 23 also includes a front portion 23.1, a side portion 23.2, and a closure portion 23.3. For preventing twisting of the spring support 23 relative to the spring seat 5, pins 23.4 are integrally formed on the front portion 23.1. The pins 23.4 engage bores 5.2 penetrating the spring seat 5 and the longitudinal member 4. The spring support 23 may be shaped to be identical to the spring support 3 in FIG. 1, whereby the manufacture is considerably simplified.

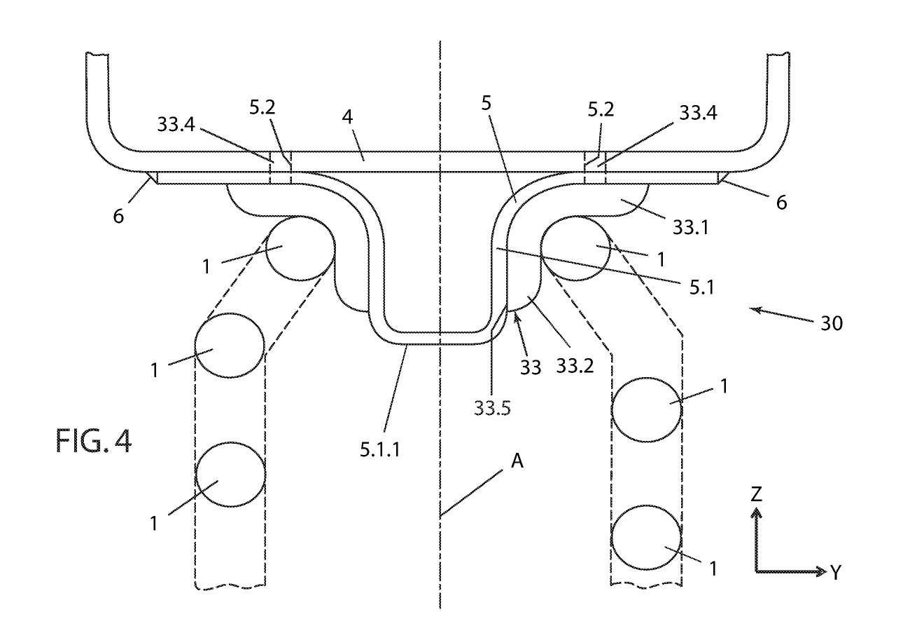

FIG. 4 shows an alternative embodiment of a spring arrangement 40 substantially corresponding to that shown in FIG. 3 and which may be joined with the embodiments shown in both FIGS. 1 and 2. A spring support 33 including a front portion 33.1 and a side portion 33.2 our once again provided. However, as in FIG. 2 a closure portion is absent, whereby the side portion 33.2 surrounds an opening 33.5 with a lower end 5.1.1 of the support structure 5.1 extending through the opening.

The spring seat is normally connected to the vehicle structure. Besides a part of the vehicle body, for example, the spring seat may be connected in particular to a part of the chassis, for example a longitudinal member. In this embodiment, a spring seat (including the support structure) may be configured as a sheet metal part and may be connected to a longitudinal member of the motor vehicle. A substantially thinner sheet metal may normally be used for the spring seat than for the longitudinal member itself, which is why a one-piece manufacture is unnecessary and/or not expedient. The spring seat is normally manufactured separately and connected by a material connection, for example, by welding or bonding to the longitudinal member. A spring seat produced as a sheet metal part may also be connected to other parts of the vehicle structure, for example a part of the vehicle body or a subframe.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A spring assembly comprising:
a spring extending along an extension axis;
a resilient spring support having a side portion and a front portion;
a spring seat having a rigid support structure arranged radially inside the spring;
said spring support side portion arranged between said support structure and said spring and said spring support front portion connected to said spring support side portion and arranged axially in front of said spring wherein said spring exerts a force against the spring support side portion and the spring support side portion exerts a force against the support structure.

2. The assembly of claim 1 wherein the spring support side portion tangentially circles the support structure.

3. The assembly of claim 2 wherein the spring support has a closure portion extending radially inward from the spring support side portion at an end thereof.

4. The assembly of claim 1 wherein said spring support includes a closure portion axially spaced from said front portion, said closure portion closing an axial end of said spring support.

5. The assembly of claim 1 wherein said spring seat is rigidly connected to a wheel carrier.

6. The assembly of claim 5 wherein said rigid support structure of said spring seat extends axially on an extension of the wheel carrier extending horizontally.

7. The assembly of claim 1 wherein the spring seat it is a sheet metal part connected to a longitudinal member of a motor vehicle.

8. The assembly of claim 1 wherein said front portion and said spring seat have complementary interlocking locking structures extending axially and preventing tangential displacement of the spring support.

9. The assembly of claim 1 including a locking structure having at least one bore in the spring seat and a pin on said spring support complementary to said bore, said pin located on the front portion of said spring support.

10. A spring assembly for a motor vehicle comprising:
a spring extending along an extension axis (A) and supported on at least one spring seat via a resilient spring support wherein said spring seat has a rigid support structure arranged radially inside said spring; and
said spring support having a side portion arranged between said support structure and said spring, and a front portion connected to said side portion and arranged axially in front of said spring wherein said spring exerts a force against said side portion and said side portion exerts a force against said support structure.

11. The assembly of claim 10 wherein said side portion tangentially circles said support structure; and
said spring support has a closure portion closing said side portion at an end thereof thereby closing an axial end of said spring support.

12. The assembly of claim 11 wherein said front portion and said spring seat have complementary interlocking locking structures extending axially and engaging one another to prevent tangential displacement of the spring support with respect to said support structure.

13. The assembly of claim 12 wherein said locking structure of said spring seat includes at least one bore located in said spring seat and said locking structure of said front portion includes a pin element located on said front portion and complementary to said bore.
